(19) United States
(12) Patent Application Publication
(10) Pub. No.: US 2011/0166895 A1
(43) Pub. Date: Jul. 7, 2011

(54) Risk Assessment Company

(76) Inventor: Thomas L. Bakos, Ridgway, CO (US)

(21) Appl. No.: 13/051,197

(22) Filed: Mar. 18, 2011

Related U.S. Application Data
(63) Continuation-in-part of application No. 12/261,081, filed on Oct. 30, 2008.

(51) Int. Cl. G06Q 40/00

(52) U.S. Cl. 705/4

(57) ABSTRACT

A Risk Assessment Company (RAC) maintains an up to date Risk Profile Data Base (RPDB) on its members based on their normal periodic updates to the RPDB. The Risk Assessment Company, therefore, can provide risk assessment results which can be utilized by a plurality of insurance carriers to determine an appropriate underwriting class for individual user subscribers who apply for insurance. The Risk Assessment Company can also provide a member with a risk assessment result report containing suggestions on how said person can better manage his or her risk exposure.

### CROSS REFERENCE TO RELATED APPLICATION

This application is a continuation in part of pending US nonprovisional patent application “Risk Assessment Company”, Ser. No. 12/261,081, filed Oct. 30, 2008. Said application is incorporated herein by reference.

### FIELD OF INVENTION

This invention unbundles the risk evaluation and selection (i.e. underwriting) function of the insurance sales process and establishes it as a separate, independent, standalone process. It provides for the “pre-underwriting” of individuals for insurance thus allowing binding offers to be made by many insurance companies all utilizing the same underwriting data. It will promote a more competitive insurance market. It will allow for a more cost effective way to underwrite and offer insurance. The cost reductions will allow for the provision of premium discounts. In addition, life, health, or other risk evaluation services will be provided to subscriber members even in the absence of any insurance application. The risk evaluation services will be useful to subscribers to improve or reduce the risks they are exposed to. A reduced insurance risk will result in additional premium discounts while the risk reduction effects are in place.

### BACKGROUND

The marketing, sale, and acquisition of life and health insurance typically develops through a process similar to the following:
An individual or other entity recognizes a risk with a potential financial impact on himself or on the entity, respectively.
Insurance to protect against the financial consequences of the risk is applied for by the individual or entity submitting an application for insurance to one or more insurance companies.
Each insurance company accepts the insurance application and undertakes to evaluate the risk through a process alternatively called risk selection, risk assessment, or underwriting. The purpose of this underwriting process is to assign the risk to a class of similar risks such that the members of such a risk class or pool will feel it fair that each share in the potential financial loss that any one or more might suffer because of the common risk to which each is exposed.
Each insurance company, as part of the underwriting step, independently collects for its own use information and data that bears on the likelihood that the risk on which insurance is applied for will occur, its frequency, or its magnitude in terms of dollar or financial loss.
Upon completion of its risk assessment process each insurance company has an underwriting result which it uses to determine whether or not it will offer insurance to the applicant and, if it does offer insurance, the terms and conditions applicable to that coverage and the premium it will charge.
If an insurance company makes an offer in response to the application, it proffers an insurance contract which the applicant may choose to accept by paying the initial premium required to put the insurance in force or reject.

The underwriting function described above has several problems:
Applicants do not know if they have insurance coverage or what it will cost until the insurance company underwriting process is complete.
Applicants who shop for insurance coverage apply to more than one insurance company and, therefore, must undergo multiple, redundant underwriting processes. This is inconvenient to the applicant and increases the total industry-wide cost of acquiring insurance coverage associated with the applicant.
Each insurance company to whom an insurance application is made independently applies an underwriting process and incurs an underwriting expense. Therefore, under the current approach, an applicant who applies for insurance to multiple insurance companies generates multiple instances of underwriting expense. Applicants will, typically, actually buy insurance from only one of the two or more insurance companies to whom they applied. The underwriting expense incurred by companies from whom insurance was not bought must be passed on and included in the premiums paid by other applicants who actually bought insurance from the insurance company. That is, insurers must recover their underwriting expenses with respect to applicants who do not purchase insurance (these are called Not Taken policies or Not Takens) from those that do which results in higher premiums to those who buy insurance.
Applicants, generally, do not have a complete understanding their health status and, so, may be surprised by the insurer's underwriting result and insurance offer if it is not in the best or near best underwriting class.
The insurance Company underwriting process introduces long delays into the insurance marketing, sales, and acquisition process.

If an insurance company were able to more effectively determine insurability by reliance on a completed independent risk assessment then insurance could be offered at guaranteed insurance premiums and at lower cost and, if accepted by the applicant, could be issued immediately.

What is needed, therefore, is an independent Risk Assessment Company (RAC) upon whom insurance companies could rely for the provision of unbundled underwriting results. That is, individual insurance companies would not each independently need to incur the expense of collecting and then evaluating the information they would otherwise need to collect and evaluate in order to underwrite an insurance applicant's risk. Instead, they would rely on a risk assessment result provided by a RAC based on information collected and evaluated by the RAC. By relying on a RAC for an underwriting result an insurance company would avoid incurring risk selection or underwriting expense itself, its insurance acquisition expenses will be reduced, and it could offer premium reductions or discounts on the insurance policies it issued which reflected its lower policy acquisition expenses.

In order for a RAC to provide an underwriting result on a timely basis in response to an insurance company request, the RAC would encourage through a subscription process individuals or other entities to contribute to and allow risk data on themselves to be collected by the RAC and stored in a Risk Profile Data Base (RPDB) in anticipation of such an insurance company request and for other relevant purposes. Said information would be evaluated by the RAC in order to create an underwriting result or risk assessment result which also would be stored in the RPDB and updated periodically so as to be kept current.

For example, in an environment in which a RAC was used by an insurance company to provide an underwriting result, applicants could indicate the insurance they were interested in purchasing in an Internet insurance shopping center, allow access to their RAC created risk assessment result, and receive immediate or near immediate binding insurance quotes from a large number of interested insurance companies based on the underwriting result provided by the RAC.

Additional benefits could be provided to members who participate in a risk assessment process managed by a RAC as described herein.

Participating members would have access to life and health expectancy statistics based on their stored personal health data in the RPDB which they could use to measure the effect of life style changes they might adopt to improve their life or health status. A RAC could provide participating members with periodic reports on their life and health expectancy such that members would have an incentive, resources, and useful feedback which would allow them to better manage their own health care which would result in improved mortality and morbidity. As a class, participating members or active individual subscribers could be expected to have beneficial risk characteristics with respect to mortality, morbidity, or other types of risk managed through the RAC process. Therefore, insurance companies relying on RAC underwriting results rather than their own independent underwriting processes would be encouraged to assign RAC subscribers who remained active to better risk classes such that the portion of the premium they paid associated with risk was reduced.

Participating members could also make their stored personal health data in the RPDB available to medical care providers or emergency health care workers in order to provide better, less expensive emergency or regular care.

The changes to the insurance industry could be enormous. For example:
For the first time, the Internet (or any other direct marketing channel) could be used to offer competitively priced, fully underwritten life insurance.
Agent or broker assisted life insurance sales would be simplified by eliminating the frustrating underwriting delay (6-8 weeks) which typically interferes with closing a sale.
RAC assisted life insurance sales would put life insurance products on an equal marketing footing with other financial products such as bank accounts, CD purchases, and securities purchase or trading, thus opening up new marketing opportunities.

The economies of the sales process introduced by the RAC application of unbundled risk assessment would create a competitive pricing advantage for insurance companies using RAC services. These advantages are created by the following:
Insurers would not incur all of the risk assessment costs directly. Some would be paid or offset upfront by the applicant through the applicant's individual subscriber membership participation in the RAC.
Insurers would incur little or no underwriting acquisition costs with respect to Not Taken policies.
Underwriters in life insurance companies would be more efficient because of greater reliance on expert systems, no waiting for requirements, and less contact with the insurance agent.
Marketing and distribution would be simplified.

### SUMMARY OF THE INVENTION

The Summary of the Invention is provided as a guide to understanding the invention. It does not necessarily describe the most generic embodiment of the invention or all species of the invention disclosed herein.

A Risk Assessment Company (RAC) builds and maintains a Risk Profile Data Base (RPDB) with respect to individual lives who subscribe to its service. The RPDB is contained and accessed in a highly secure electronic environment, such as a HIPPA compliant system.

The RPDB is a principal asset of an RAC. In order to build and maintain the RPDB and provide services to its customers and clients, the RAC will design and develop technologies consistent with existing, successful technologies and expertise in related businesses.

Data and information collected by the RAC will be collected with the authority and approval of the individual subscriber participating members. A RAC will collect for inclusion in its RPDB not only data and information relative to and necessary to evaluate the life, health, or other risk, as appropriate, of individual subscribers, the RPDB will also utilize such data and information to evaluate the risk in order to produce a risk assessment result which will be stored in the RPDB. Said risk assessment result will be kept current by the use of periodic updates to the data and information stored in the RPDB.

Subscribers to the services provided by an RAC comprise individuals who would benefit from (for example):
A constant storage location for accurate and complete medical records regardless of doctor, job, residence, or insurance changes;
Immediate emergency access to medical records when traveling away from home;
Personalized medical reports with a full, written explanation of all test results;
A life and health expectancy analyses summarizing the risks associated with medical or lifestyle decisions;
A risk assessment result based on information stored in the RPDB updated periodically so as to remain current, said risk assessment result designed to measure current exposure to life, health, or other risk relevant to the subscriber such that said risk measurement could be used to place a dollar value on the risk as, for example, in classifying risk to an appropriate insurance premium class, and allow an individual subscriber to better manage his or her exposure to risk; and
Access to an on-line medical library.

These benefits of membership in an RAC are designed to encourage individuals to subscribe to the services the RAC provides. Individual subscribers may be asked to pay a fee for full membership benefits.

Companies or entities which function as contributors to, or users of, health or life expectancy information with respect to individuals or groups of individuals would be user subscribers of the RAC. For example, entities providing health related services publicly or privately in areas such as:
insurers/reinsures underwriting functions;
health care providers;
labs;
pharmacies;
paramedical facilities;
medical records data base technologies;
medical information libraries; and
Internet service providers,
   would receive value from being user subscribers to RAC provided services.

The process of utilizing data and information stored in the RPDB managed by a RAC to produce a risk assessment result is an unbundled risk assessment approach meaning that the risk assessment or underwriting step of a typical insurance marketing, sales, and acquisition process is performed by an entity which is not an insurance company. That is, this step is performed by a RAC. In addition, such an unbundled risk assessment result will be initiated and used for a purpose not necessarily directly related to the marketing, sale, or acquisition of insurance. The risk assessment result, principally, will be provided for the benefit of individual subscribers to the RAC so as to allow them to better measure and manage the risks to which they are exposed.

However, the availability to insurance company user subscribers of unbundled risk assessment results available in a RAC RPDB will significantly change the way life insurance is marketed, sold, and acquired. An individual RAC subscriber's risk class could be quickly and easily derived by reference to the individual subscriber's risk profile contained in the RPDB or the stored risk assessment result. As a result, an insurance company user subscriber which received an application for insurance from an individual subscriber could avoid its own underwriting step and the expense and time associated with implementing it and rely, instead, on the risk assessment result available from the RPDB to establish a premium rate class. By reliance on said risk assessment result the insurance company could make an immediate, binding offer to the individual subscriber, reduce its policy acquisition expenses, and benefit from insuring an individual who was actively involved in managing insurance risk. Access to the RAC database and available risk assessment result could be made in order to determine insurability at the time an insurance application is made, or the RAC data base could be used to pre-determine insurance eligibility and make binding insurance offers to RAC subscribers independent of a prior application. Because of the reduction in expense to the insurance company resulting from the elimination of the insurance company's underwriting step, the insurance company would be able to offer insurance at a premium lower than what would otherwise be required.

In addition, by insuring individuals in a class, that is, individual subscribers to a RAC, who were actively involved in measuring and managing their risk, the cost of life, health, or other risk would likely be lower than it would otherwise be. This would be so because individual subscribers would be encouraged to seek preventive or helpful medical care for conditions revealed by the RAC risk assessment process and result which they otherwise would have been unaware of, would be likely to adopt known healthier or less risky life styles or practices as revealed by the RAC, or make other changes to their risk profile so as to capture known improvements in exposure to risk.

An individual subscriber, because of the perceived value and benefits of membership in the RAC, would be willing to incur a reasonable cost necessary to create and maintain a risk profile in the RPDB. This would be so, in part, because the individual subscriber's costs would be kept low by building the development of the RAC on the elimination of expense redundancies in industries which utilize RAC services. That is, fees paid by company and business entity user subscribers to the RAC for services may be used to reduce or eliminate subscriber fees for individual subscribers. In addition, premium reductions available to individual subscribers because of their participation as a RAC member would also reduce, offset, or eliminate a fee that might be charged for membership.

An individual subscriber experience in a RAC would, typically, proceed as follows:
a) An individual subscribes to become an individual subscriber to the RAC by paying a membership fee, if any, as required and either providing or authorizing data and information relevant to risks affecting the individual to be provided to the RAC to populate a RPDB. Said risks to which the individual is exposed may be life, health, or any other risk which causes the individual subscriber to be exposed to potential dollar loss or strain as a result of the occurrence of a contingent event.
b) An individual continues to be an individual subscriber and an active participant by periodically causing his RPDB to be updated in order to keep the data and information in the RPDB current and relevant.
c) An individual subscriber will have access to a risk assessment result based on the data and information populating the individual subscriber's record in the RPDB. Said risk assessment result may be stored in the RPDB and will be updated periodically by the RAC to reflect the impact on the individual subscriber's risk of any changes to the data and information in the RPDB.
d) An individual subscriber may use his risk assessment result as a measure of his exposure to risk and may choose to manage said risk exposure by making changes in life style or practice or seek preventive or helpful medical care as may be advised by or informed by the RAC provided risk assessment result so as to reduce exposure to risk.
e) An individual subscriber may seek insurance coverage from an insurance company by authorizing said insurance company to have access to information contained in the RPDB specifically including the risk assessment result provided by the RAC. Said insurance company would classify the individual subscriber to a risk class consistent with the individual subscriber's RAC risk assessment result or accept a classification made by the RAC on behalf of the insurance company and may offer binding insurance coverage subject only to the individual subscriber's payment of the required premiums.
f) The individual subscriber may shop for insurance by applying to more than one insurance company authorizing each access to the RPDB and the subscriber's risk assessment result. The individual subscriber would be free to accept or reject one or more insurance contracts offered on the basis of the RAC risk assessment result subject to any terms or conditions an insurance company may establish with respect to its offer. For example, in order to avoid an over insurance situation, an insurance company may only agree to issue its insurance coverage if no other insurance coverage is accepted.

The RAC model may also be applied to other types of risk. For example, as individual credit risk is currently assessed by a number of companies by reference to credit risk data bases, other types of risk to which individuals are exposed and which are not currently effectively addressed, may also be incorporated into the risk assessment services provided by an RAC. Examples of these other types of risk include but are not limited to: casualty risk (flood, geological, weather, accident, travel, etc.), personal economic risk (home purchase, personal investment, etc.), enterprise risk (business failure, product quality, etc.), or any other risk that may financially impact personal life style or business relationships. The RAC could, as a service to its subscribers, evaluate and assess these other types of risks and provide evaluations in terms of probabilities of failure or success. For example, a subscriber intending to purchase a home could receive a financial risk evaluation relative to the likelihood the subscriber would be able to avoid default on a mortgage and foreclosure taking into account the terms of the mortgage and likely economic scenarios.

The RPDB would be tested and verified using internal consistency checks and by reviews by individual subscribers of their individually stored data. Insurance company user subscribers would be allowed to audit the underwriting conclusions reached by application of RAC underwriting processes applied to the RPDP. These audits, for example, may be facilitated by insurer-provided test records where an insurer could compare an RAC underwriting evaluation to the insurer's own underwriting evaluation. The RAC underwriting process may allow for variations applied relative to each user subscriber insurance company or other user subscriber company relying on a risk evaluation from the RAC.

### BRIEF DESCRIPTION OF FIGURES

FIG. 1 is a table of sample life underwriting requirements.

FIG. 2 is a table of marginal underwriting acquisition expense.

FIG. 3 is a table of expense assumptions for a 10 year term policy.

FIG. 4 is a table of estimated marginal underwriting expenses.

FIG. 5 is a table of estimated allocated underwriting expenses.

FIG. 6 is a table of estimated RAC expense savings for a 10 year term policy.

FIG. 7 is a table of expense assumptions for a whole life policy.

FIG. 8 is a table of a whole life policy example.

### DETAILED DESCRIPTION

Persons of ordinary skill in the art will recognize that the following disclosure is illustrative only and not in any way limiting. Other embodiments of the disclosure will readily suggest themselves to such skilled persons having the benefit of this disclosure.

One economic, or financial, basis for a Risk Assessment Company (RAC) is the elimination of expense redundancies typically found in the mechanisms of the healthcare and insurance services currently provided to individual consumers. The elimination of these expense redundancies will reduce expenses for each of the service providers and benefit consumers by providing better services at lower cost.

The expense reduction is made possible by combining the similar functions performed by each service provider. The basic elements of the similar functions would be modified (if necessary) to accommodate the specific need of each company. Each company would then piggyback its service on this common function which would only need to be performed once with its benefits shared multiple times.

A second economic, or financial, basis for a RAC is that the risk assessment tools and results provided to individual subscribers will result in better management of the risks to which said individual subscribers are exposed. That is, as a class, some or all individual subscribers by reference to the risk assessment results will take action to reduce risk exposure which will have the effect of reducing the adverse effects of risk on the class of individual subscribers as a whole, that is, on average. While many individual subscribers may be able to utilize the risk assessment tools and results provided to them by the RAC to reduce the adverse effects of risk on them personally, the circumstances of the life, health, or other risk to which some individual subscribers are exposed may not allow all individual subscribers to each individually benefit from a reduction in adverse effects of risk they would otherwise have incurred. However, no individual subscriber will suffer a worse adverse effect than he or she would have suffered if he or she had not been an individual subscriber and many will have improved or reduced the impact of the adverse effects of risk exposure upon them. Therefore, the class of individual subscribers, on average or as a whole, will experience improved or reduced overall adverse effects of risk.

### DEFINITIONS

Individual Subscriber: An individual subscriber is a person who signs up to participate in and receive the products or services provided by a RAC. A sign up may involve the payment of a fee or periodic fees to the RAC. Participation will involve the individual subscriber providing or agreeing to have provided to the RAC data and information relative to risks to which the individual subscriber is exposed. An agreement by the individual subscriber to update said data and information per a periodic schedule established by the RAC will also be required. Said data and information will be stored in the RPDB. Active participation by an individual subscriber to update data and information in the RPDB relevant to the individual subscriber is required to maintain status as an individual subscriber.

Risk Profile Data Base (RPDB): A RPDB is a collection of data and information relative to the risk or risks to which individual subscribers are exposed which is useful in measuring or quantifying either the likelihood that a risk event will occur, the frequency of occurrence of a risk event, or the severity of an occurrence or occurrences of a risk event in terms of financial impact expressed in money, for example, dollars. For example, said data and information with respect to life and health risk will include medical and nonmedical information pertinent to the individual subscriber. Medical data and information relative to an individual subscriber may include items such as: build; blood pressure; smoking status; family history; attending physician statement records and a history of prior medical treatment; records of disease or injury; genetic information; and other such information. Nonmedical data and information relative to an individual subscriber may include items such as: financial information; employment information; information on avocations; travel; and other such information reflective of exposure to life and health risk. In addition to risk data collected and stored in a RPDB relative to an individual subscriber, a RPDB may also include one or more risk assessment results derived or calculated from an analysis of the stored data together along with other relevant information necessary or helpful in evaluating said risk assessment results. Said risk assessment results will be added to the RPDB.

Risk Assessment: A risk assessment is an evaluation of the data and information in the RPDB relevant to an individual subscriber for the purpose of producing a risk assessment result. A risk assessment may also be called: risk selection; risk classification; or underwriting.

Risk Assessment Result: A risk assessment result is an estimate or classification resulting from a risk assessment which is indicative of the level of risk to which an individual subscriber is exposed. A risk assessment result may be reported as a rate (e.g., 7 deaths per 1,000) or as relative risk related to a standard (e.g., mortality equal to 200% of a standard mortality table). Alternatively, a risk assessment result may be expressed as assignment to a risk class (e.g., preferred, standard, smoker, or nonsmoker). Any quantification of level of risk based on an evaluation of data stored relative to an individual subscriber in the RPDB is a risk assessment result.

Risk Class: A risk class is a grouping of individuals, e.g., individual subscribers, each of whom experiences similar levels of risk with respect to a particular risk.

Unbundled Risk Assessment: Unbundled risk assessment is risk assessment which is done to produce a risk assessment result as a standalone end product not dependent on any other service or product being directly provided by the entity doing the risk assessment. The risk assessment produced by a RAC is an unbundled risk assessment since it is the result of a standalone process intended to produce a risk assessment result as an end product. Said risk assessment result might be used as input for a multiple number of subsequent processes. In contrast, risk assessment or underwriting, which is done as part of an insurance marketing, sale, and acquisition process is not unbundled since it is merely one of many internal steps done by an insurance company, for example, in its process of marketing, selling, and issuing an insurance policy.

Binding Offer: As used herein, binding offer relates to the marketing, sale, and acquisition of an insurance contract. A binding offer is an offer to insure made by an insurance company which specifies exactly the conditions and terms under which the insurance coverage offered will become effective and be placed in force. These terms and conditions do not involve any conditional result not controllable by the entity to which the binding offer is made. For example, an individual subscriber to whom a binding offer to insure is made need only comply with the terms and conditions of a binding offer, including paying the required premium, in order for the insurance coverage to become effective. Said binding offer will not depend on an uncertain future result.

User Subscriber: A user subscriber is an entity, not an individual subscriber, which signs up to participate in and receive the products or services provided by a RAC. A sign up may involve the payment of a fee, periodic fees, or other charges to the RAC by said user subscriber. A user subscriber may, for example, be an insurance company which signs up to utilize risk assessment results calculated by the RAC with respect to individual subscribers.

Expert Underwriting System: An expert underwriting system is a software algorithm implemented on a computer that emulates the problem solving behavior of an expert in evaluating data and information relative to an insurance risk in order to arrive at an underwriting decision.

### How an RAC would Operate

A Risk Assessment Company would be used to provide services to individual and user subscribers who are affected by any sort of risk.

The RAC would ideally be a national company having established relationships with health care providers and paramedical facilities. Through these relationships, the medical data specifically needed for life insurance underwriting would be acquired.

An RAC-negotiated fee structure with these health care providers should be able to take advantage of the fact that the RAC's clients are also participants in health care plans that rely on these health care providers for direct health care services. By making multiple uses of medical data and eliminating redundant testing, an expense savings will be realized.

For example, HMO or PPO coverage provided through a group health plan typically allows a periodic, routine physical exam for, say, a $15-$25 co-pay or encounter fee. These plans also cover the cost of lab tests or other tests considered necessary by the examining physician. As an add-on to this periodic health evaluation, an individual could be offered, or request, what might be called an insurance or mortality risk assessment supplement.

This supplement would direct that medical tests or analysis which are required for insurance underwriting but are not normally part of a routine medical exam be performed. For example, a blood draw might have an additional fee associated with it to cover the additional costs associated with additional tests done on the blood sample. There are a variety of different sets of laboratory tests that can be done on that blood sample each with an additional separate fee. Each said blood test has a specific objective, for example: various sorts of blood counts; allergy testing; tests for auto immune diseases; cancer detection; determining cholesterol levels; diabetes testing; hormone levels; testing for infectious diseases; organ function; etc. By associating multiple purposes to a single blood draw redundant blood draws can be avoided and overall fees reduced. An additional option may be that the amount of supplemental information collected and the fee could be dependent on a level selected by the individual which would be based on how much life or health insurance or other type of insurance he or she anticipated needing.

Within the RAC, underwriters or risk selection evaluation experts, aided perhaps by electronic expert underwriting systems will evaluate the medical information provided as required by the individual subscriber's subscription agreement. The RAC will also gather the non-medical data essential for a life insurance risk evaluation or other type of risk evaluation using authorizations provided by the individual subscriber as required by the individual subscriber's subscription agreement. Said non-medical data may include, for example, financial information, employment information, information on avocations, travel, or family history that may affect mortality, morbidity, or other risk. Using all of this information, the RAC will create a risk assessment result for the individual subscriber stored in the Risk Profile Data Base (RPDB), coded per a standardized process relative to other individual subscribers and maintained in a secure electronic data-base.

The use of an unbundled risk assessment company such as the RAC will facilitate the sale of fully underwritten life insurance in the e-commerce marketing environment by making the risk profile information provided reliable. It will do this economically by piggybacking on periodic medical exams that ought to be part of every individual's health care program, whether or not they are considering the purchase of life or health insurance.

### Advantages of the RAC Approach

### Insurance Company Advantages

Use of a Risk Assessment Company (RAC) would allow an insurer to unbundle the risk evaluation and selection (underwriting) process from the insurance sales process. The RAC would provide an independent risk assessment result on individual lives for a fee. This risk assessment would be done either before or early in the sales process. It could be used by any insurance company to provide binding offers of insurance to individual subscribers who apply for insurance. An individual subscriber applicant would merely need to accept the offer in order to put insurance immediately into effect on his or her life subject only to conditions disclosed in the offer.

An insurer user subscriber would tend to use a RAC risk assessment result as an underwriting selection tool when the underwriting cost savings it expected to realize in doing so was more than any additional risk cost it might expect from use of what might be a less precise risk selection process. A less precise risk selection process is a risk selection process which is expected to produce for a risk class a higher risk cost than might otherwise exist if, for example, the insurer user subscriber had used its standard underwriting processes.

Therefore, an insurer user subscriber may use a calculation such as the following to determine whether or not use of a RAC risk assessment result will result in reduced underwriting expenses wherein the absolute value of said reduction in underwriting expenses was in excess of any increased risk costs. Therefore, an insurer using the RAC process which provides a risk assessment result would be able to offer an insurance product for the same or a lower premium to an insurance applicant in a specified risk class more quickly than would otherwise be possible by avoiding the need for the underwriting step in a typical insurance sales process.

E_{P}=Standard underwriting process expense assumption built into product pricing by insurer user subscriber for a risk class. This expense may vary by product, issue age, policy year, underwriting class, amount applied for, type of insurance, or other factors considered by the insurer user subscriber to affect underwriting expense.

E_{RAC}=Charge made to insurer user subscriber by RAC for use of its risk assessment result. This charge may vary by product, age, underwriting class, amount applied for, type of insurance, and other factors which affect the cost incurred by the RAC to collect and maintain information on its data base.

E_{S}=E_{P}−E_{RAC} Where E_{S} is the expense savings or reduction in underwriting expenses realizable by the insurer user subscriber relative to the said risk class by using a RAC risk assessment result in place of insurer user subscriber's standard underwriting process.

Q_{P}=Standard risk cost pricing assumption made by insurer user subscriber for said risk class. Said risk cost pricing assumption may be expressed as a table of rates which vary by characteristics affecting risk such as: issue age; sex; policy year or duration; risk or underwriting class; amount of insurance; or other relevant factor.

Q_{A}=the additional risk cost, if any, expected to result from use of the RAC risk assessment result as the sole underwriting, risk selection tool. That is, Q_{A} may be equal to zero. Said additional risk cost may be expressed as a table of rates or as an addition to the Q_{P} rates either as a constant addition or a factor multiplier and may vary by characteristics affecting risk such as: issue age; sex; policy year or duration; risk or underwriting class; amount of insurance; or other relevant factor.

If E_{S}>Q_{A} then an insurer user subscriber would gain an expense pricing advantage in using a RAC risk assessment result which would reduce underwriting expenses in place of its standard underwriting processes.

Said insurer user subscriber could then use the excess of underwriting expense savings over any additional risk cost, E_{S}−Q_{A}, to re-price its insurance product reflecting its lower net underwriting cost per the following process:

Prem_{P}=Insurer user subscribers original premium.

Insurer user subscriber would calculate a new premium, Prem_{NP}, priced using Q_{P} as the risk cost and (E_{P}−E_{S}+Q_{A}) as the underwriting expense cost such that the premium savings which could be passed on to the insurer user subscriber's customers would equal Prem_{NP}−Prem_{P}.

In the discussion above a person of ordinary skill would understand that the costs discussed above, although derived from rates, would be expressed in dollars or a similar unit of currency related to the same units of insurance coverage so as to be comparable.

Insurers using the RAC would realize significant expense savings that they could reflect as lower premiums. Expense savings to insurance companies would result from several sources:
Insurers would not incur risk assessment or underwriting costs directly. In effect, the insurer underwriting function would be outsourced to a RAC.
Insurers would incur no selection costs with respect to Not Taken policies.
Marketing and distribution would be simplified, made more efficient, and be less costly.

Individuals who had decided or been advised that life insurance should be a part of their financial program would be encouraged to utilize the services of a RAC and pay any required service fees because of the significant insurance cost advantage of an insurance policy issued using the RAC process. Applicants could receive an almost immediate payback of their upfront RAC subscriber charges, if any, through first year premium savings provided by insurers offering insurance products discounted because of issue through the RAC process.

The traditional cost of the medical portion of the risk assessment process would be further reduced by piggybacking it onto the periodic medical/physical exams which are typically provided for a small encounter fee or co-pay as part of most insured health care plans (HMOs, PPOs, etc.).

In addition to the fact that the RAC risk assessment process would provide life insurers with the ability to issue fully underwritten, lower priced life insurance products immediately, other advantages exist:
Insurance carriers could distance themselves from the selection activity making their underwriting staff more efficient.
In a RAC environment, life, health, and other types of insurance would be on an equal marketing footing with all other financial products.
The use of the Internet in the sale of life, health, or other forms of insurance would be enabled. This would encourage paperless, signature-less contracts and additional economies in distribution.

A life insurer not using a RAC process could find itself in a very uncompetitive position.

### Individual Subscriber Advantages

RAC services would be designed to have a standalone value making them additionally desirable to many consumers, even those not currently contemplating the purchase of life, health, or other types of insurance.

For example, an RAC would utilize the medical and non-medical risk assessment data it collected in order to provide the individual subscriber with an individualized risk assessment result. Said result, for example, would evaluate life and health risk by providing life and health expectancies and access to a personalized medical information data base relevant to the individual subscriber's risk profile. This could be used by subscribers to understand and manage their current health. Also, the RAC could examine other types of risk to which the individual subscriber was exposed and provide similar risk assessment results and advice.

A method for providing a binding offer of life or health insurance to an individual subscriber would comprise the following steps:
a) Accepting a subscription from an individual causing said individual to become an individual subscriber wherein said individual subscriber's participation will involve the individual subscriber providing or agreeing to have provided to the RAC data and information relative to risks to which the individual subscriber is exposed and wherein the individual subscriber agrees to update said data and information per a periodic schedule established by the RAC.
b) Receiving in a secure electronic database, the Risk Profile Data Base (RPDB), said data and information provided to the RAC and periodically updated per the individual subscriber agreement.
c) Calculating an unbundled risk assessment result by an electronic expert underwriting system wherein said risk assessment result was derived solely from data and information stored in the RPDB and wherein said risk assessment result is stored in the RPDB.
d) Receiving a request from a user subscriber insurance company for a risk assessment result relative to an individual subscriber wherein said request was initiated by an application for insurance made by said individual subscriber.
e) Comparing said risk assessment result to said insurance company's underwriting requirements in order to produce an underwriting decision consistent with said underwriting requirements wherein said underwriting decision consists of either a rejection of insurance or an offer of insurance in a specified underwriting class for a specified premium.
f) Transmitting said underwriting decision to said insurance company and, if said underwriting decision results in an offer of insurance, also transmitting a binding offer of insurance to said individual subscriber.

### Security Issues

An individual subscriber's use of a RAC could be an effective way to address his or her privacy concerns. The individual subscriber to the RAC service would clearly establish ownership of his or her own medical/underwriting information by contract or agreement with the RAC as part of establishing an individual subscriber relationship. Access to an individual subscriber's risk profile on the RPDB would only be available with proper authorization from the individual subscriber. An individual subscriber, therefore, would receive a benefit or service from a third party, say an insurance company, from results derived from information in his RPDB without actually conveying said information to the third party.

### Subscriber Costs Offset

Any subscriber fee that might be charged to an individual to use the RAC process could be reimbursed in a number of ways. For example:
An insurance company could pay an individual subscriber applicant for access to the applicant's risk assessment result.
The individual subscriber could either receive insurance coverage at a lower rate, reflecting the insurer's cost savings, or the issuing company could provide another form of premium credit with respect to coverage they actually issue.
Insurer cost savings would be derived from, at least, two sources: (1) By use of the risk assessment result stored in the RPDB, the insurance company user subscriber would avoid a significant part of the cost of underwriting the individual subscriber applicant itself and, therefore, would have lower policy acquisition expenses which could be passed on to the individual subscriber applicant in the form of a lower premium; and (2) an individual subscriber who routinely updated his or her risk profile by following procedures established by the RAC would be in a class of lives, that is, the class of individual subscribers, who, as a class, could be expected to have improved or lower risk than a similar class of lives who were not individual subscribers.

With respect to the improved or lower risk to individual subscribers, such improved or lower risk would be experienced by the individual subscriber class on average. Said improved or lower risk would be influenced and encouraged by the ability of individual subscribers to better manage and, thereby, improve or lower their risk as a result of the feedback they received from the RAC risk assessment results. Therefore, class membership implies that individual subscribers as a group would use the RAC risk assessment results provided to them to better manage risk. This is distinguished from other approaches which might require that an individual subscriber actually do something individually or actually participate in some physical activity (other than being an individual subscriber who maintains an up to date status in the RAC) in order to receive a lower insurance premium or insurance premium discounts.

It is also anticipated that individual subscribers who qualify for lower insurance premiums or insurance premium discounts will only continue to qualify for said lower premiums or premium discounts for so long as they remain individual subscribers to a RAC and comply with RAC procedures established to maintain an up to date RPDB record. Said individual subscribers will be called as active individual subscribers.

Periodic physical exams are a normal part of a health care program. An individual subscriber, for example, could keep his or her risk profile current through a periodic update in connection with periodic physicals.

### Other Benefits

The RAC could also provide an individualized health evaluation to its individual subscribers based on the data it collected. This would consist of an unbiased evaluation of the mortality or other risk class to which the client belonged, along with comparative data to help the client evaluate any deviation, positive or negative, from standard.

Detailed risk assessment results could be provided with explanations of what the raw numbers mean, and how they interrelate. In a written report or through a secure Web site, the RAC could provide suggestions for possible changes in life style, habits, diet, activity, medications or other risk management process that could have an impact on the risk assessment result. Therefore, even if the risk assessment result was not used as a basis to purchase life or other type of insurance, it would be of value to an individual subscriber interested in better managing his or her health or other type of risk. To the extent that said risk management options came at a cost, the RAC could provide to individual subscribers the cost and benefit of implementing various risk management strategies in dollars, for example, such that individual subscribers could make risk management decisions in a financially efficient manner.

### Possible Future Benefits

Use of a RAC's risk assessment result could be expanded into the financial and credit areas. For example, a risk assessment result could place dollar values on the relative probabilities of risk events an individual is exposed to. These risk assessment results would allow the consumer to make educated decisions with respect to life style or insurance/self-insurance choices with respect to (for example) life, health, auto, homeowners, and credit/debt issues. More broadly, risks included in the RAC process might include but are not limited to: casualty risk (flood, geological, weather, accident, travel, etc.), personal economic risk (home purchase, personal investment, etc.), enterprise risk (business failure, product quality, etc.), or any other risk that may financially impact personal life style or business relationships.

As medical technology develops, additional services could be added as they became economic to provide. For example, individual subscriber genome analysis could be matched against known drug-genome interactions. It is becoming evident that, in order for some prescription medication to be effective in any individual, a gene enabled process must exist in order for the body to properly breakdown and use the drug. The RAC could alert its individual subscribers to personally ineffective or potentially dangerous drug interactions. A customer may be allowed to restrict his or her own access to personal genome data so that the RAC would report only on controllable outputs. The consumer could choose to remain uninformed with respect to conditions for which there is no known treatment or avoidance mechanism. Therefore, consumer use of this data for adverse selection could be avoided without impacting access to genetic information useful in potentially successful treatments.

### A Life Underwriting Example

This analysis of the application of the RAC process is focused on the middle issue age ranges (18-65) and moderate insurance application face amounts (under $2,000,000). Experience with the process will allow extension of the eligible age range and face amounts applied for in excess of $2 million. It is expected, that special circumstances (e.g. very large face amounts or unusual risks) may require exceptions to the sole use of unbundled risk assessment.

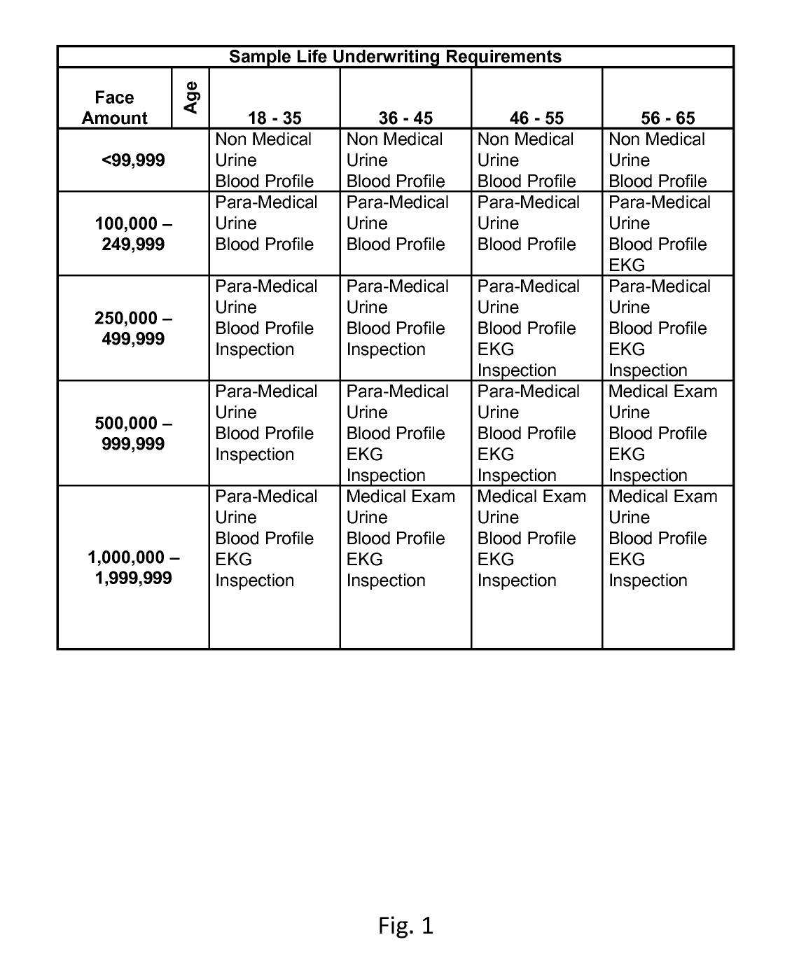

FIG. 1 provides a typical set of underwriting limits and requirements for the initial age range and face amounts contemplated.

Different companies may indicate different breaks and splits for additional requirements, but the above table is representative of the general industry requirements and is a reasonable reference for determining pricing cost savings that would be provided by the RAC risk assessment process.

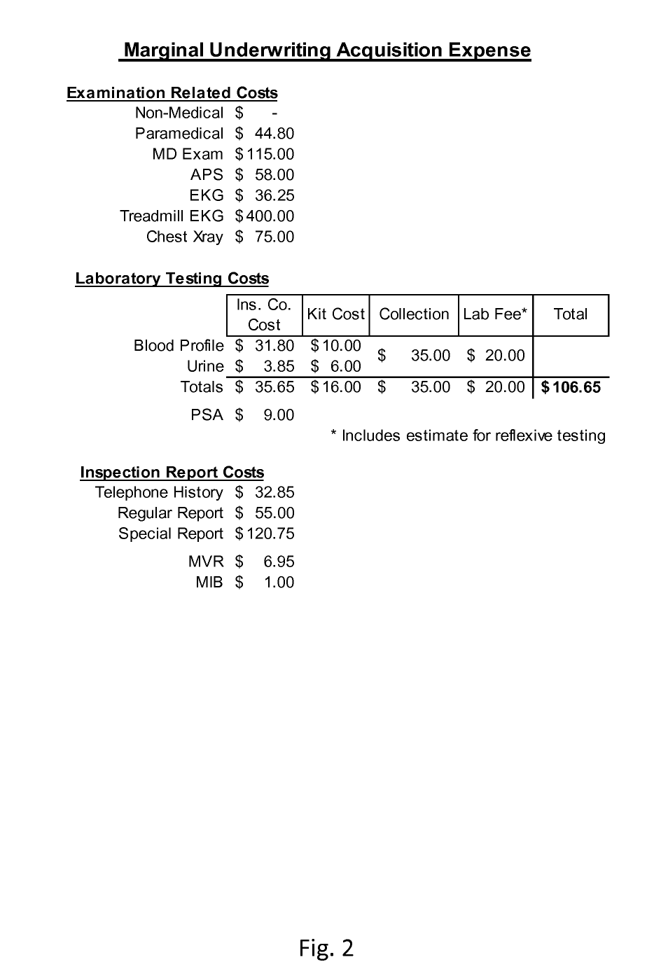

FIG. 2 indicates typical expenses associated with the medical examinations and reports indicated in the underwriting limits and requirements table.

Marginal underwriting acquisition expenses are intended to identify the expenses paid to outside providers for information used by a life insurance company to underwrite a life insurance applicant. These are the expenses incurred for each applicant underwritten whether or not a policy is actually issued. Therefore, when these expenses are factored into pricing calculations they are grossed up to cover the cost of underwriting Not Taken policies.

In addition to these marginal expenses, a life insurer will incur in house underwriting, policy issue, and administrative expenses which will be combined with the marginal expenses and allocated in an expense study to calculate per policy, per thousand, and percent of premium expense pricing assumptions.

### Estimate of RAC Savings

A reasonable estimate of the average expenses to issue and maintain a life insurance policy is shown in the table below.

### 10 Year Term Example

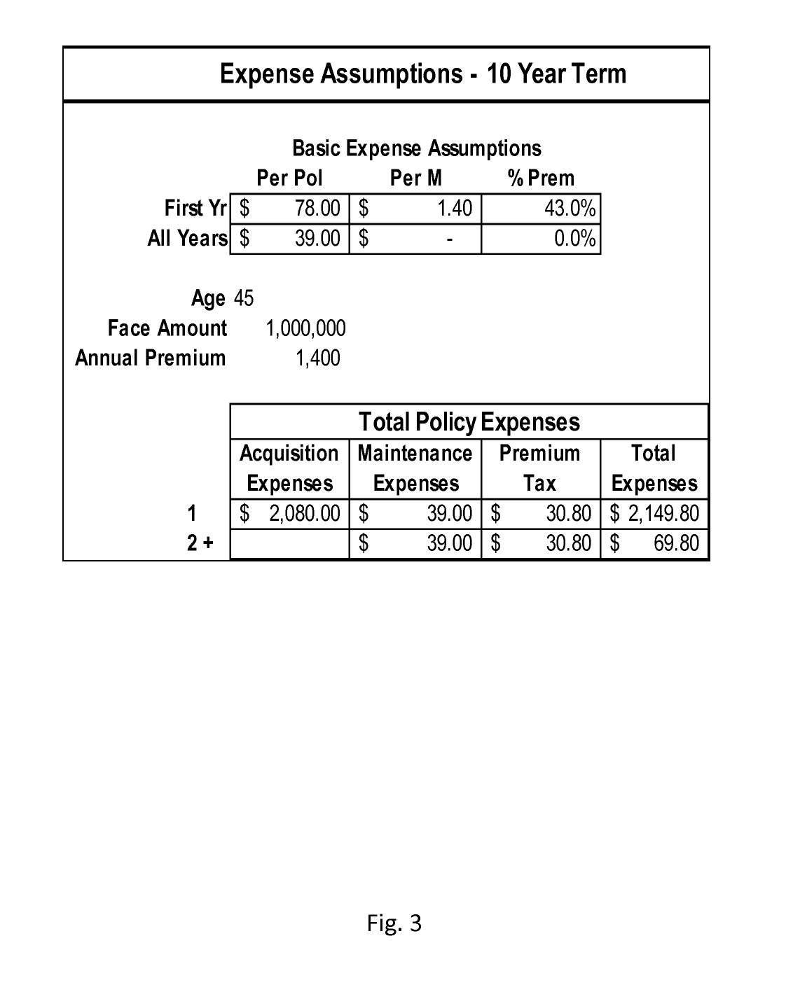

FIG. 3 shows unit expense assumptions applied to a hypothetical $1,000,000 Ten Year Term level premium policy issued to a Male Age 45. It is assumed the policy is issued in a company's very best underwriting class. By way of example, such a policy might have an annual premium of about $1.40/M or $1,400 in total. Premium taxes are assumed to be 2.2% of premium to calculate the total expenses shown.

Therefore, the total acquisition expenses for this 10 Year Term policy as shown in column 1 of the table above are $2,080.

By using a Risk Assessment Company, a life insurer would not directly incur the marginal underwriting expenses required to provide the Medical Exam, blood profile, home office specimen (urine), EKG, PSA, APS, Inspection Report, Motor Vehicle Record search, and the MIB check required by the company's underwriting requirements.

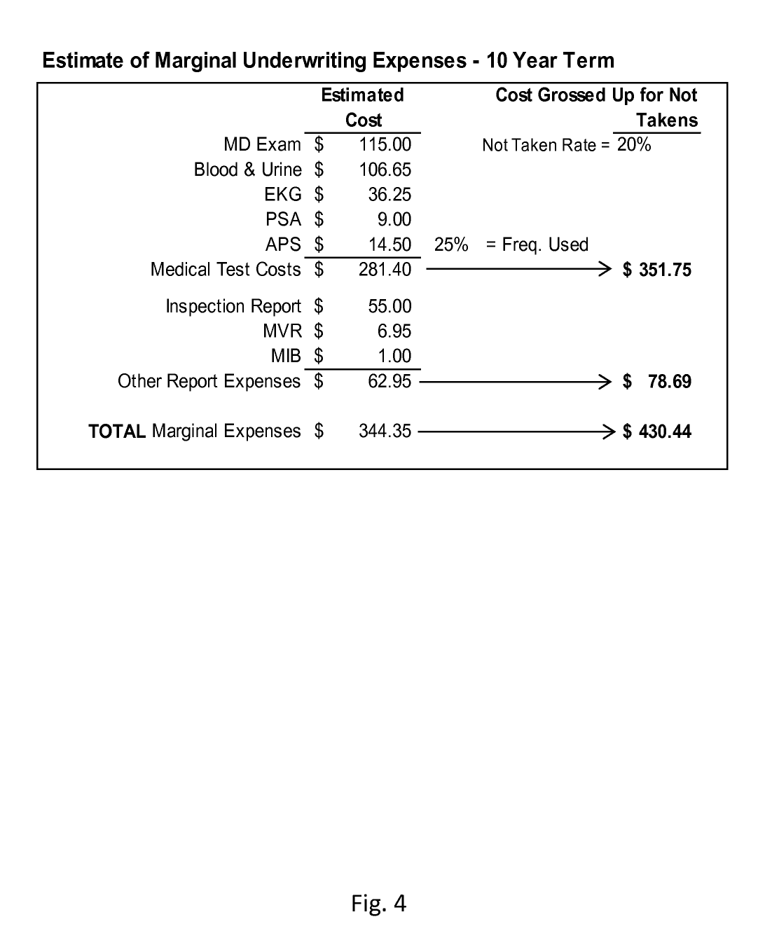

FIG. 4 itemizes the expenses for these examinations and reports that the insurer would avoid.

A Not Taken rate of 20% is assumed. Therefore, while the total marginal cost for the underwriting requirements is $344.35, pricing would need to reflect a cost of $430.44 in order to cover the marginal costs associated with underwriting policies that were Not Taken.

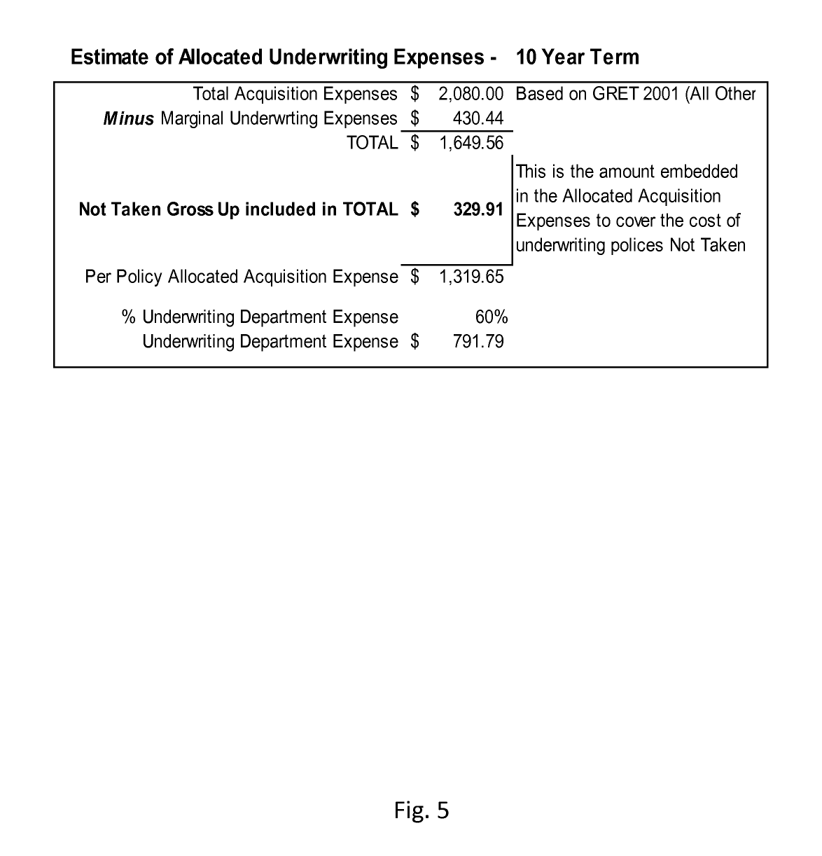

In addition to the marginal underwriting expenses associated with underwriting an insurance policy, there are also allocated underwriting expenses. That is, the allocated expenses relate to the fixed or overhead expenses the insurance company incurs in running an underwriting department. The allocated underwriting expenses are calculated as follows as shown in FIG. 5.
The marginal underwriting expenses ($430.44) are subtracted from the total acquisition expenses ($2,080.00) incurred in a normally underwritten insurance policy to determine the allocated underwriting expenses.
The result is multiplied by 20% to estimate the amount ($329.91) included as a gross up in allocated underwriting expenses to cover Not Taken insurance policies.
The gross up for Not Taken amount calculated above ($329.91) is subtracted to calculate a Per Policy Allocated Acquisition Expense ($1,319.65).
60% of the Per Policy Allocated Acquisition Expense ($1,319.65) or $791.79 in this example is assumed to be incurred by underwriters in the life company's Underwriting Department in order to review applicant risk profile data and create a risk assessment or underwriting decision. Depending on insurer, this percentage may be higher or lower.

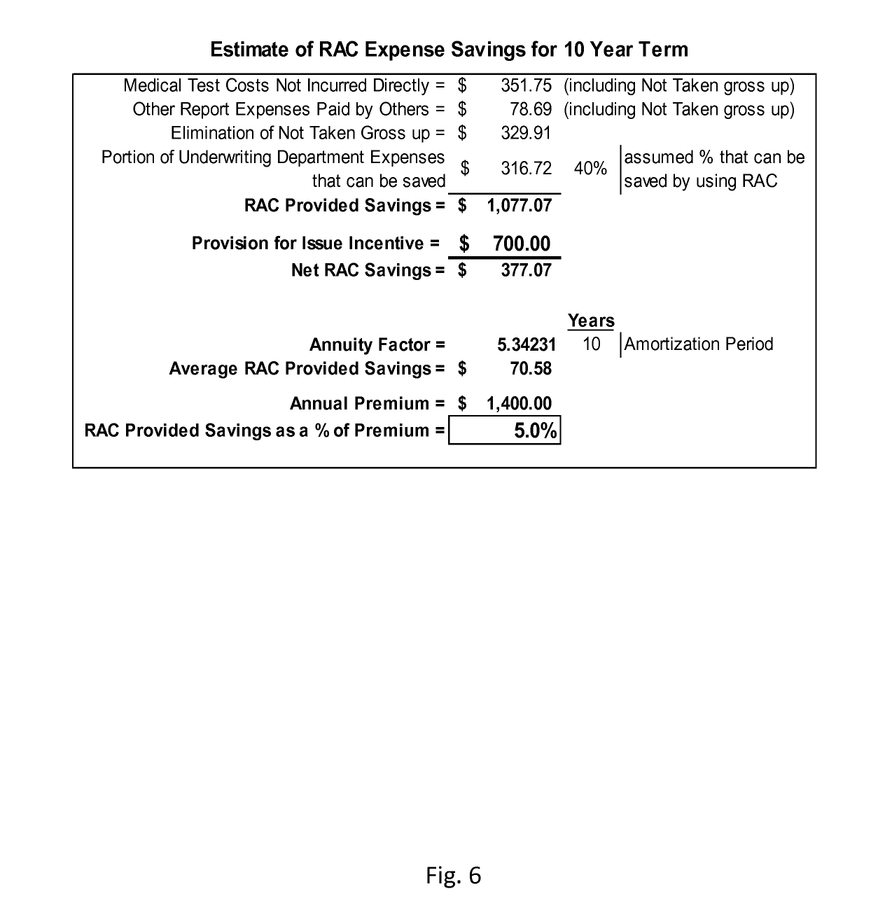

A policy issued using the RAC process could experience a reduction in direct underwriting costs as shown in FIG. 6.

It is assumed that the identified allocated Underwriting Department expense ($791.79) could be reduced by 40% through the use of the RAC for an expense savings of $316.72. This expense reduction would be driven by a the more efficient use of underwriting staff, less time required for underwriting, a reduction in underwriting staff, and a greater reliance on expert underwriting systems and could vary by insurance company.

As shown in the example above, the insurer could save acquisition costs totaling $1,077.07 for this 10 Year level premium Term policy.

In this example a $700 first year issue incentive provided by the insurer to defer the acquisition expenses “fronted” by the applicant could be provided and still reduce acquisition expenses by $377.07. In fact, the incentive the insurer could provide to applicants who actually purchase insurance from the company would, very likely, be well in excess of the costs actually incurred by the applicant.

The $377.07 net first year expense savings, when spread over the ten year term of the insurance policy, would allow the insurer to reduce its annual premium by, at least, $70.58 or 5% of the $1,400 annual premium.

Thus, in this example, a 10 Year Term policy issued using the RAC unbundled risk assessment process could provide a first year issue incentive equal to 50% of the premium in addition to reducing the annual premium by 5%.

### Whole Life Example

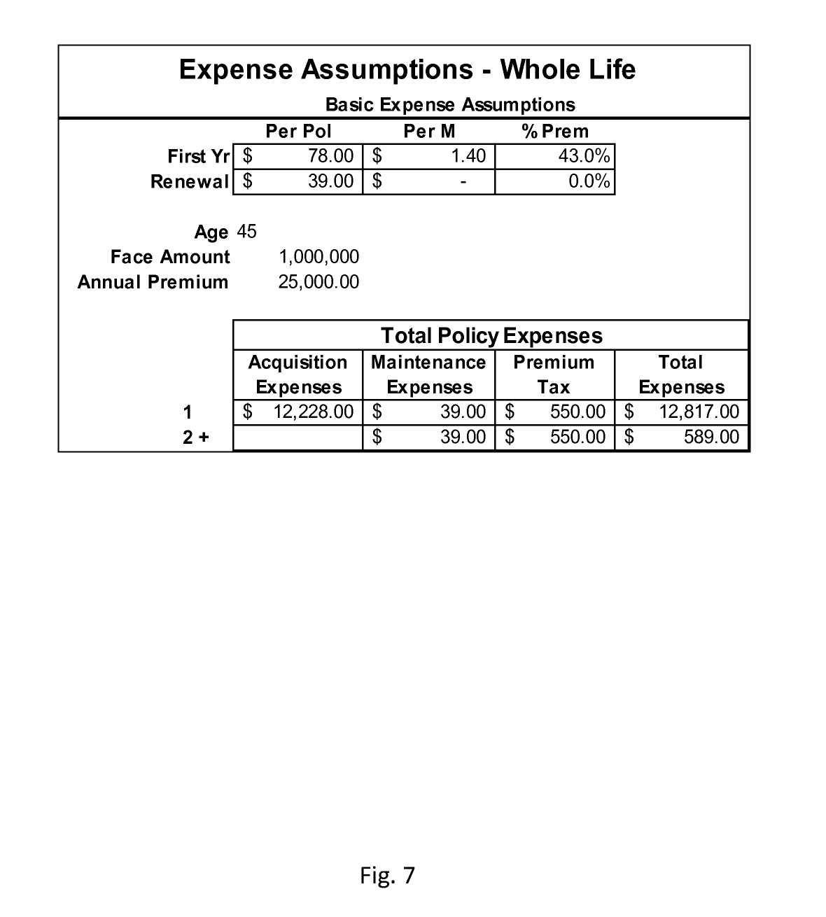

For a Whole Life policy, typical average expenses might be as shown in FIG. 7.

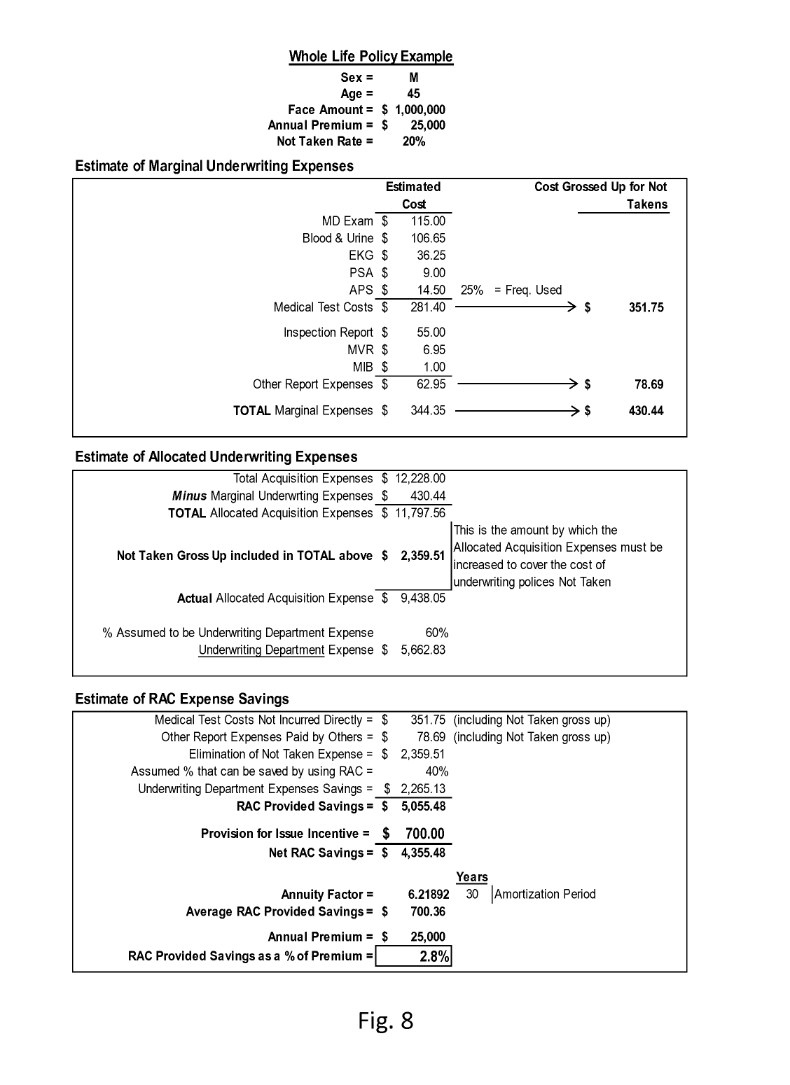

FIG. 8 shows the full development of the expense savings as a percent of premium for a typical WL policy issued to a Male Age 45 in the very best underwriting class.

For a Whole Life policy the use of the RAC unbundled risk assessment process would allow a 2.8% premium reduction and provide the $700 first year issue incentive.

### RAC Sources of Revenue

A Risk Assessment Company can provide services in multiple related areas, each one of which could be a source of revenue. The value of the RAC services would be derived from the overall expense reductions made possible by the elimination of redundancies that now exist in these related fields.

The RAC can develop revenue from services provided to each of the following:
Insurance companies which become user subscribers and utilize the RAC process to underwrite insurance applications based on the Risk Profile Data Base (RPDB) maintained by the RAC.
Health care providers which become user subscribers and utilize the RPDB and other RAC systems for maintaining patient electronic health records; electronic data interchange between physicians, hospitals, pharmacies, and health plans; and physician office management information systems.
Individual consumers who become individual subscribers and to the RAC for personalized life and health risk assessments and access to personal health data and focused medical information provided via the Internet. An attempt would be made to provide these services to the individual subscriber free of charge. Revenue from this source could be derived principally from the value the availability of this information service provided to the health care providers.
Employers and other organizations allowed authorized access to individual subscriber health information by individual subscribers in lieu of physical exams they might otherwise require.
Research, business, or governmental organizations paying fees for access to anonymous, reliable health data for analysis, business planning, product development, research, or studies.

### The Consumer Benefits are Compelling

An RAC approach would create the following opportunities and advantages that would benefit the consumer with respect to the acquisition of life insurance:
The consumer would be a more attractive customer to an insurance carrier because:
   Their pre-approved risk class would be indicative of a serious interest in acquiring life insurance and foster competition among companies.
   There would be relatively little expense risk for the insurance carrier in providing an insurance quote or illustration.
   Coverage could be made effective immediately eliminating potential dissatisfaction with time service and administrative expense.
The consumer would have easily utilized flexibility in the selection of an insurer or insurers.
   That is, competitive, guaranteed quotes could be made available from many sources including the Internet.
   Large amounts of coverage could be diversified over a number of insurers with no additional selection processes or requirements.
The consumer would be able to put coverage into effect instantly as illustrated.
   The opportunity to effectively utilize the Web would be enabled.
   Paperless, signature-less policies could be issued with resulting issue and maintenance expense savings reflected in lower product pricing.
The consumer would receive benefit from the expense savings resulting from the elimination of redundancy in the use of medical facilities.
Independent Brokers would be better enabled to focus on and satisfy the financial needs of their client consumers.

### Additional Services Provided by the RAC

The RAC could provide an individual subscriber with a report customized to his or her specific risk situation. It would be designed to provide that individual subscriber with an accurate and independent assessment of the risks (life, health, and other) to which he or she was exposed and the extent of that exposure.

The RAC report could go further. In addition, and importantly, the risk assessment result provided could indicate the discretionary changes the individual subscriber could make in his or her life style that could have an impact on the risks or costs associated with those risks. The risk assessment result could be designed to provide, in an easily understandable way, information pertinent to a complete understanding of the individual's risk scenario.

While initially envisioned as a life and health risk assessment result provider, the RAC, in order to completely satisfy the life insurance risk selection process, could additionally address financial elements associated with an individual subscriber. For example a financial evaluation would determine acceptable maximum amounts of coverage with respect to an individual life and establish insurable interest relationships. Or, for example, an RAC could provide individual subscribers with changes in the value of their in force life insurance policies as a result of changes in their health, mortality, or life expectancy which could allow them to better evaluate life settlement offers.

The RAC services could also be naturally extended into an evaluation of credit risk through use of credit history or “insurance” scoring techniques which are finding an application in property and casualty insurance underwriting. On the P&C side, there is a belief that a good credit history will be indicative of a good auto or home owner's risk. By adding this functionality to the services it provides, the RAC may find a roll in the P&C insurance industry as well. Credit history scores may have a similar application in life insurance underwriting. For example, good credit may be equivalent in some way to a generally healthy life style or to “truthfulness” in response to questions on an application.

Risks (or, costs) associated with extensive use of credit could be identified and less costly credit approaches might be recommended when the cost of credit is evaluated. For example, higher deductibles to lower auto insurance rates or other forms of consumer self insurance could be suggested (if appropriate) with the dollar savings utilized to, for example, save an “emergency fund”.

An individual subscriber can be given access to a Web site in which information unnecessary for the basic evaluations provided could be input, anonymously, in order to get additional evaluations. Through such access, an individual subscriber could play with “what if” scenarios to determine the impact on his or her life, health, financial, or credit scenario of discretionary changes they might make in their life style. For example, the effect of giving up smoking or losing weight on life and health expectancy and the costs associated with those changes with respect to potential health care or retirement costs could be evaluated. Or, the potential dollar savings associated with changing limits or deductibles for existing P&C coverages could be explored.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this disclosure.

1. A method for providing a binding offer of life or health insurance coverage, said method comprising:
a) accepting a subscription from an individual causing said individual to become an individual subscriber of a Risk Assessment Company (RAC) wherein said individual subscriber's participation will involve said individual subscriber providing or agreeing to have provided to said RAC data and information relative to risks to which said individual subscriber is exposed and wherein said individual subscriber agrees to update said data and information per a periodic schedule;
b) receiving in a secure electronic database, the Risk Profile Data Base (RPDB), said data and information provided to the RAC and periodically updated per the individual subscriber agreement;
c) calculating an unbundled risk assessment result wherein said risk assessment result was derived solely from data and information stored in the RPDB and wherein said risk assessment result is stored in the RPDB;
d) receiving a request from a user subscriber insurance company for a risk assessment result relative to an individual subscriber wherein said request was initiated by an application for insurance made by said individual subscriber;
e) comparing said risk assessment result to said insurance company's underwriting requirements in order to produce an underwriting decision consistent with said underwriting requirements wherein said underwriting decision consists of either a rejection of insurance or an offer of insurance in a specified underwriting class for a specified premium;
f) transmitting said underwriting decision to said insurance company and, if said underwriting decision results in an offer of insurance, also transmitting a binding offer of insurance to said individual subscriber.

2. The method of claim 1 wherein the unbundled risk assessment is calculated by an electronic expert underwriting system.

3. The method of claim 1 which further comprises the steps of:
g) comparing said risk assessment result to one or more additional insurance company's underwriting requirements in order to produce an underwriting decision consistent with said underwriting requirements wherein said underwriting decision consists of either a rejection of insurance or an offer of insurance in a specified underwriting class for a specified premium;
h) transmitting said one or more underwriting decisions to said one or more insurance companies and, if said underwriting decisions result in an offer of insurance, also transmitting a binding offer of insurance relative to said one or more insurance companies to said individual subscriber.

4. The method of claim 1 wherein said user subscriber insurance company offers an insurance policy with a premium which is less than or equal to the premium it would have charged for the same coverage without reliance on a RAC risk assessment result and wherein said premium is calculated using Q_{P}+Q_{A} as the risk cost and E_{S}=(E_{P}−E_{RAC}) as the underwriting expense cost where:
a) Q_{P}=Standard risk cost pricing assumption made by insurer user subscriber for said risk class wherein said risk cost pricing assumption may be expressed as a table of rates which vary by characteristics affecting risk such as: issue age; sex; policy year or duration; risk or underwriting class; amount of insurance; or other relevant factor;
b) Q_{A}=the additional risk cost, if any, expected to result from use of the RAC risk assessment result as the underwriting, risk selection tool wherein said additional risk cost may be expressed as a table of rates or as an addition to the Q_{P} rates either as a constant addition or a factor multiplier and may vary by characteristics affecting risk such as: issue age; sex; policy year or duration; risk or underwriting class; amount of insurance; or other relevant factor;
c) E_{P}=Standard underwriting process expense assumption built into product pricing by insurer user subscriber for a risk class wherein said underwriting expense may vary by product, issue age, policy year, underwriting class, amount applied for, type of insurance, or other factors considered by the insurer user subscriber to affect underwriting expense;
d) E_{RAC}=Charge made to insurer user subscriber by RAC for use of its risk assessment result; and
e) E_{S}=E_{P}−E_{RAC}.

5. A system, said system being specifically modified to carry out the steps of:
a) accepting a subscription from an individual causing said individual to become an individual subscriber of a Risk Assessment Company (RAC) wherein said individual subscriber's participation will involve said individual subscriber providing or agreeing to have provided to said RAC data and information relative to risks to which said individual subscriber is exposed and wherein said individual subscriber agrees to update said data and information per a periodic schedule;
b) receiving in a secure electronic database, the Risk Profile Data Base (RPDB), said data and information provided to the RAC and periodically updated per the individual subscriber agreement;
c) calculating an unbundled risk assessment result wherein said risk assessment result was derived solely from data and information stored in the RPDB and wherein said risk assessment result is stored in the RPDB;
d) receiving a request from a user subscriber insurance company for a risk assessment result relative to an individual subscriber wherein said request was initiated by an application for insurance made by said individual subscriber;
e) comparing said risk assessment result to said insurance company's underwriting requirements in order to produce an underwriting decision consistent with said underwriting requirements wherein said underwriting decision consists of either a rejection of insurance or an offer of insurance in a specified underwriting class for a specified premium;
f) transmitting said underwriting decision to said insurance company and, if said underwriting decision results in an offer of insurance, also transmitting a binding offer of insurance to said individual subscriber.

6. The system of claim 5 wherein the unbundled risk assessment result is calculated by an electronic expert underwriting system

7. The system of claim 5 which further comprises the steps of:
g) comparing said risk assessment result to one or more additional insurance company's underwriting requirements in order to produce an underwriting decision consistent with said underwriting requirements wherein said underwriting decision consists of either a rejection of insurance or an offer of insurance in a specified underwriting class for a specified premium;
h) transmitting said one or more underwriting decisions to said one or more insurance companies and, if said underwriting decisions result in an offer of insurance, also transmitting a binding offer of insurance relative to said one or more insurance companies to said individual subscriber.

8. The system of claim 5 wherein said user subscriber insurance company offers an insurance policy with a premium which is less than or equal to the premium it would have charged for the same coverage without reliance on a RAC risk assessment result and wherein said premium is calculated using Q_{P}+Q_{A} as the risk cost and E_{S}=(E_{P}−E_{RAC}) as the underwriting expense cost where:
f) Q_{P}=Standard risk cost pricing assumption made by insurer user subscriber for said risk class wherein said risk cost pricing assumption may be expressed as a table of rates which vary by characteristics affecting risk such as: issue age; sex; policy year or duration; risk or underwriting class; amount of insurance; or other relevant factor;
g) Q_{A}=the additional risk cost, if any, expected to result from use of the RAC risk assessment result as the underwriting, risk selection tool wherein said additional risk cost may be expressed as a table of rates or as an addition to the Q_{P} rates either as a constant addition or a factor multiplier and may vary by characteristics affecting risk such as: issue age; sex; policy year or duration; risk or underwriting class; amount of insurance; or other relevant factor;
h) E_{P}=Standard underwriting process expense assumption built into product pricing by insurer user subscriber for a risk class wherein said underwriting expense may vary by product, issue age, policy year, underwriting class, amount applied for, type of insurance, or other factors considered by the insurer user subscriber to affect underwriting expense;
i) E_{RAC}=Charge made to insurer user subscriber by RAC for use of its risk assessment result; and
j) E_{S}=E_{P}−E_{RAC}.
